(19) United States
(12) Patent Application Publication
(10) Pub. No.: US 2010/0007224 A1
(43) Pub. Date: Jan. 14, 2010

(54) Precision ground stator assembly for solenoid actuator and fuel injector using same

(75) Inventors: Avinash R. Manubolu, Edwards, IL (US); Jayaraman K. Venkataraghavan, Dunlap, IL (US); Vladimir Theodorof, Dunlap, IL (US); Stephen Lewis, Chillicothe, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/217,625

(22) Filed: Jul. 8, 2008

(51) Int. Cl. H02K 15/16; H02K 41/035

(52) U.S. Cl. 310/14; 29/596

(57) ABSTRACT

A method to set a small air gap by improving the parallelism between the armature and the stator assembly includes attaching a guide sleeve to a pole piece and grinding the surfaces on the guide sleeve and the pole piece after the attaching step to improve parallelism. By decoupling the armature assembly from a valve member in a fuel injector assembly, an improved parallel orientation between the armature assembly and the stator assembly can be achieved by grinding the outer surface of the guide sleeve perpendicular to the planar bottom surface of the stator assembly in a single chucking. When the solenoid is energized, the armature is at a final air gap with the flux piece parallel to the bottom surface of the armature and the armature not in contact with the valve member.

### TECHNICAL FIELD

The present disclosure relates generally to stator assemblies in solenoid actuators and more particularly to a guided solenoid assembly for use in fuel injectors.

### BACKGROUND

People skilled in the art recognize the goal to mass produce a solenoid actuator having smaller initial and final air gaps with improved parallelism between a stator assembly and an armature in a cost efficient manner. Even though it may be possible to produce a solenoid actuator assembly having a very small air gap and where the armature is parallel to the stator assembly, those in the art recognize there are significant costs involved in mass producing such assemblies.

Typical solenoid actuated fuel injectors include an armature connected to a valve member that controls the flow of fuel and/or pressure through the fuel injector. By having the armature connected to the valve member, the movement of the armature within the stator assembly may be compromised. By moving the armature with the valve member coupled thereto, the armature might travel at reduced speeds due to the increased mass, and any attempts to improve parallelism with the stator assembly were also hindered due to the tolerance stack ups that invariably increase during production with more connected parts. Moreover, in the past, some armature assemblies included a hard guide piece that was part of, or drove a fuel injection valve member, and a soft armature piece that served to enhance the magnetic forces acting on the armature. In order to improve parallelism and maintain a predetermined initial and final air gap, manufacturers used various category parts that took into account the inaccuracies that existed in the dimensions of the solenoid actuator assembly despite establishing very tight tolerances during mass production.

When the coil of the solenoid is energized, the armature moves towards the stator assembly, moving the valve member, and thereby controlling the fluid flow and/or pressure in the fuel injector. When the coil ceases to be energized, a mechanical spring or other bias forces the armature away from the stator assembly, causing the valve member to return to its original position and thereby controlling the fluid flow and/or pressure in the fuel injector again. It is known in the art that the time taken for the solenoid actuator, and hence the control valve of a fuel injector, to move from a first position to a second position and back again is a function of the highest possible forces acting on the armature over the shortest possible travel distance. It is desired by those in the art to reduce the time taken for the armature to travel from the initial air gap position to the final air gap position and back to the initial air gap position.

The magnetic forces acting on the armature are functions of the electromagnetic properties of the armature, the initial and final air gap between the armature and the stator assembly and the parallel orientation of the armature with reference to the stator assembly, including others. It is well known in the art that a magnetic field in a solenoid has the greatest force when the armature is parallel to the stator assembly and the air gap between them is as small as possible. Having a larger initial air gap will translate to the armature having a lower initial attraction force and maybe a larger travel distance, hence increasing the time taken to travel from the initial air gap position to the final air gap position. Having a smaller final air gap will allow for a smaller initial air gap and also allow a stronger magnetic force to act on the armature, hence increasing the speed at which the armature travels from the final air gap position to the initial air gap position and back. A lack of parallelism can create side forces leading to imbalance and increased wear at guide interfaces.

There has been an ongoing effort to improve parallelism in prior references, while striving to achieve the smallest final air gap. One prior art reference, U.S. Patent Application Publication No. US2006/0138374 A1 teaches the use of an adjustable spacer coupled between the armature housing and the stator. The spacer is adjusted depending on the tolerance variation of the assembled parts. U.S. Pat. No. 6,550,699 teaches the use of plating a hard film layer on the armature as a spacer. The prior art, although geared towards achieving some of the goals this disclosure aims to achieve, have been met with limited success.

The present disclosure is directed to one or more of the problems set forth above.

### SUMMARY

In one aspect, a method of assembling a stator assembly of a solenoid actuator is described. The stator assembly comprises a pole piece and a guide sleeve. The method of assembling the stator assembly includes the steps of attaching the guide sleeve into a pole bore defined in the pole piece. The method further includes the steps of forming a guide bore through the guide sleeve after the attaching step, and forming a planar bottom surface on the pole piece after the attaching step. The step of forming the guide bore through the guide sleeve and the step of forming the planar bottom surface on the pole piece includes the step of orienting the axis of the guide bore perpendicularly relative to the planar bottom surface on the pole piece. An alternate step is orienting the planar bottom surface on the pole piece perpendicular or relative to the axis of the guide bore.

In another aspect, a fuel injector assembly comprises a solenoid actuator assembly, which includes a stator assembly and an armature. The stator assembly has a pole piece, a guide sleeve attached to the pole piece and a guide bore defined by an inner surface of the guide sleeve. The guide bore has an axis and the pole piece has a planar bottom surface. The axis of the guide bore is oriented perpendicular relative to the planar bottom surface on the pole piece, or in the alternative, the planar bottom surface on the pole piece is oriented perpendicular relative to the axis of the guide bore. The armature has a guide piece and a flux piece. The armature is slidably movable between a first position where the armature is in contact with a stop surface of the pole piece and out of contact with a valve member, and a second position where the armature is out of contact with the stop surface and in contact with the valve member.

### BRIEF DESCRIPTION OF THE DRAWINGS

FIG. 1 is a sectioned front view of a fuel injector according to the present disclosure;

FIG. 2 is an enlarged sectioned front view of the control valve portion of the fuel injector shown in FIG. 1;

FIG. 3 is an enlarged sectioned front view of the fuel injector shown in FIG. 1;

FIG. 4 is an enlarged sectioned front view of the armature assembly of the fuel injector of FIG. 1; and

FIG. 5 is an enlarged sectioned front view of another embodiment of a solenoid actuator assembly according to the present disclosure.

### DETAILED DESCRIPTION

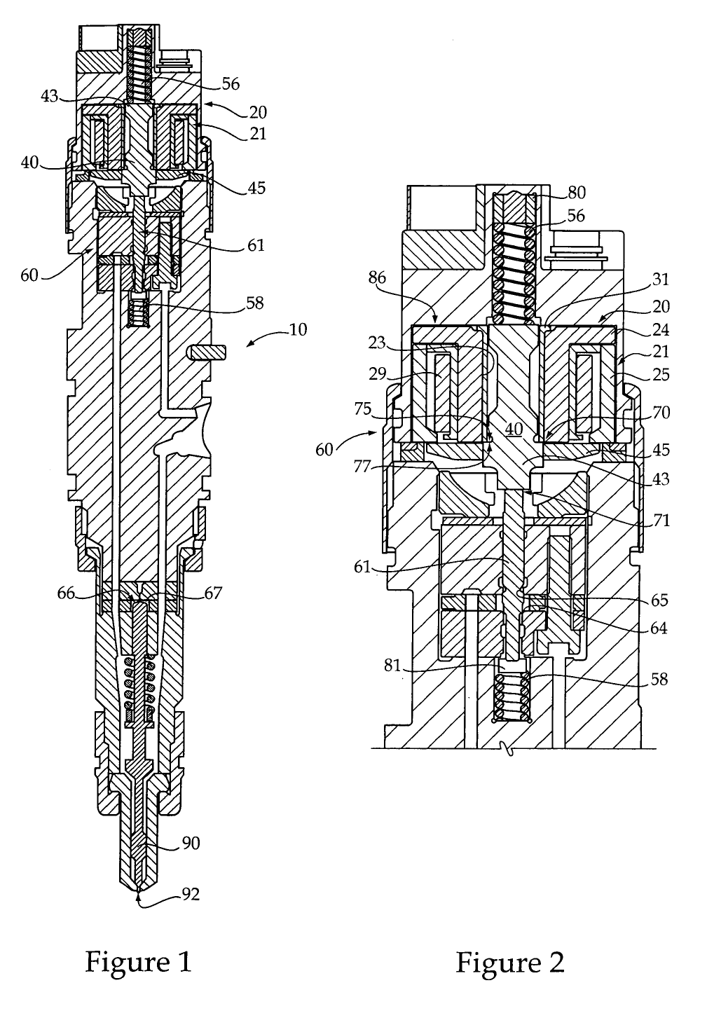

Referring to FIG. 1, a fuel injector 10 includes an electronically controlled valve assembly 60 and a valve nozzle 92 that is opened and closed by a valve needle 90. The electronically controlled valve assembly 60 includes a solenoid actuator assembly 20, a valve member 61, a first spring 56 having a first pre-load and a second spring 58 having a second pre-load. The solenoid actuator assembly 20 includes a stator assembly 21 and an armature assembly 40. The stator assembly 21 and armature assembly 40 are both made from various assembled parts. Valve needle 90 includes a closing hydraulic surface 66 exposed to fluid pressure in a needle control chamber 67. Energizing and de-energizing the solenoid actuator assembly 20 moves the valve member 61 to change pressure in the needle control chamber 67 (via fluid connections not shown) to allow the valve needle 90 to open and close the valve nozzle 92 in a conventional manner.

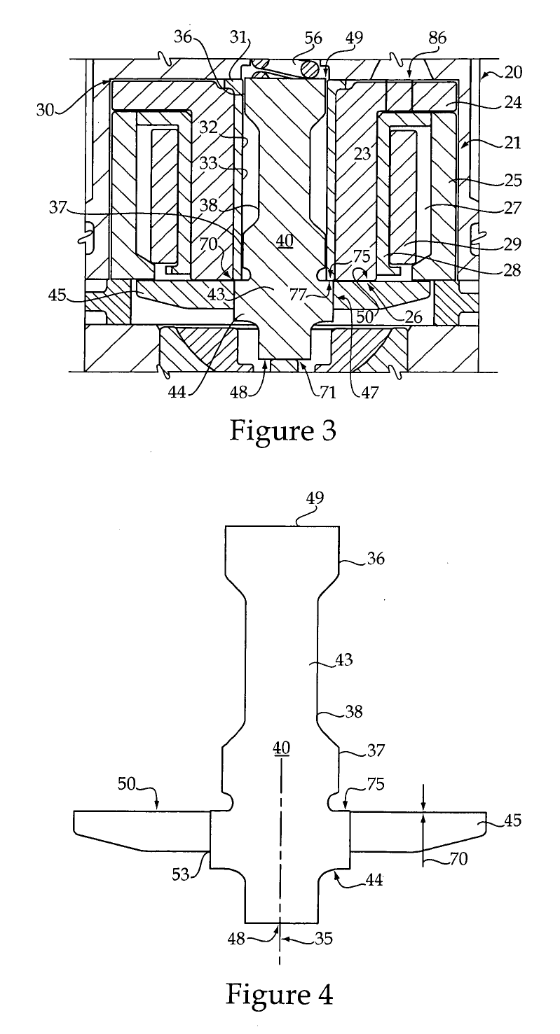

Referring now to FIGS. 2 and 3, the stator assembly 21 includes an outer pole piece 25 attached to an inner pole piece 24, such as via welding them together at the weld joint 30. In other embodiments, other attachment mechanisms and locations may be used to attach the inner pole piece 24 to the outer pole piece 25. The pole pieces 24 and 25 may have co-planar bottom surfaces. As the pole pieces 24 and 25 are attached to each other, in this embodiment they share the same bottom surface, which is referred to as the planar bottom surface 26. In one embodiment, a coil 29 is carried on a bobbin 28 inside a cavity formed within the pole pieces 24 and 25. The remainder of the space between the pole pieces may be filled with plastic filler 27. Inner walls of the inner pole piece 24 form a pole bore 23 through which a guide sleeve 31 is attached o the inner pole piece 24. In one embodiment, the guide sleeve 31 may be press fitted through the pole bore 23 so that it fits snugly along the inner walls of the inner pole piece 24. Other embodiments may contemplate other ways of attaching the guide sleeve 31 to the inner walls of the inner pole piece 24, such as a weak press fit accompanied by a weld. The guide sleeve 31 has an inner diameter surface 32, which defines a guide bore 33. The guide bore 33 has a longitudinal axis 35 that is perpendicular to the planar bottom surface on the pole piece 26. The guide sleeve 31 may have a stop surface 77, which may be the bottom surface on the guide sleeve 31 and in one embodiment, it may be flush with, or be considered part of the planar bottom surface 26 of the stator assembly 21. In one embodiment of the disclosure, the planar bottom surface on the entire stator assembly is machined to form the planar bottom surface 26 on the stator assembly 21. Those skilled in the art will recognize that the guide sleeve 31 and pole pieces 24 and 25 may be made from the same or different materials. For instance, pole pieces 24 and 25 may be chosen for their magnetic flux channeling capacities, but the guide sleeve material may be chosen more for wear characteristics in guide bore 33 and stop surface 77.

Referring now to FIG. 4, the armature assembly 40 includes a guide piece 43 made of a hard material which exhibits impact resistant properties, and a flux piece 45 made of a soft material which exhibits high magnetic properties. The flux piece 45 may be attached to the guide piece 43 at a weld joint 53. In many embodiments, the pieces may be attached by welding the pieces together, press fitting them or using a combination of a light press fit and a weld, among other attachment strategies. The guide piece 43 includes at least one guide surface 36 and 37, an enlarged diameter portion 44 and a stop surface 75 located on the portion 44. In the embodiment shown in FIG. 4, the guide piece 43 has a first guide surface 36, a second guide surface 37 and a reduced diameter section 38. By reducing the diameter on the guide piece 43 in section 38, the armature assembly 40 has a lower mass and therefore, requires a smaller force to move the armature assembly 40. In one embodiment, the outer surfaces on the guide piece, including the first guide surface 36 and second guide surface 37, may be ground after attaching the guide piece 43 to the flux piece 45 in such a manner that when the guide piece 43 is received in the guide bore 33, the guide clearance between the guide piece 43 and the guide sleeve 31 is so small that it results in a much improved parallelism between the top surface 50 on the flux piece 45 and the planar bottom surface 26. Thus, armature assembly 40 may be guided through the guide bore 33 via an interaction between the guide piece 43 and the guide sleeve 31. Furthermore, in an exemplary embodiment, the stop surface 75 on the guide piece 43 is not planarly flush with a top surface 50 on the flux piece 45. The distance between the stop surface 75 on the guide piece 43 and the top surface 50 on the flux piece 45 along the axis 35 of the guide bore 33 is equal to a predetermined final air gap 70. In one embodiment of the disclosure, a final air gap of about 0.05 mm can be achieved on a consistent basis while maintaining efficient operating costs. The term “about” means that when the number is rounded to a like number of significant digits, the numbers are equal. Thus, both 0.045 and 0.054 are about 0.05.

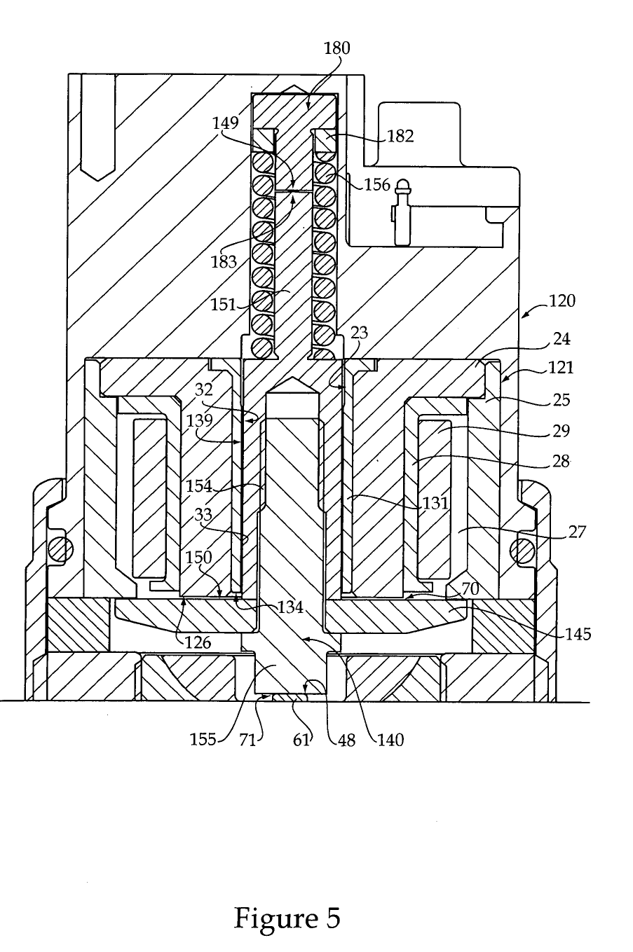

Referring now to FIG. 5, the solenoid actuator assembly shown is another exemplary embodiment of the disclosure. Here, the armature assembly 140 includes a guide piece 151 attached to a flux piece 145 by means of a contact pin 155. The contact pin 155 may be threaded onto the guide piece 151 via threads 154 to secure the flux piece 145 to the guide piece 151 or via other attachment means. The guide piece 151 may be constructed with less stringent tolerances so that the outer guide surface 139 on the guide piece 151 may be ground after assembling the armature assembly 140. Inaccuracies, such as having a non-perpendicular orientation between the outer guide surface 139 on the guide piece 151 and the planar top surface 150 on the flux piece 145, that may occur during the assembly step, can be corrected by grinding the outer guide surface 139 on the guide piece 151 perpendicular to the top surface 150 on the flux piece 145, after assembling the flux piece 145 and the guide piece 151 to form the armature assembly 140. Improved parallelism between the top surface 150 on the flux piece 145 and the planar bottom surface 126 on the stator assembly 121 will be achieved if the top surface 150 on the flux piece 145 is perpendicular to the outer guide surface 139 on the guide piece 151 and the inner diameter surface 132 on the guide sleeve 131 is perpendicular to the planar bottom surface 126 on the stator assembly 121. By ensuring that perpendicularity is achieved, the guide piece 151 can travel within the stator assembly with an orientation that allows the top surface 150 on the flux piece 145 to remain parallel with the planar bottom surface 126 on the stator assembly 121. Furthermore, in order to achieve more accurate perpendicularity between the outer surface 139 on the guide piece 151 and the top surface 150 of the flux piece 145, the grinding may be performed in a single chucking. Alternatively, steps might be taken to ensure that top surface 150 is planar prior to assembly, and then using that surface as a reference when grinding the outer guide surface 139.

The stator assembly 121 is an alternative embodiment of the stator assembly 21 in FIG. 1 and could be substituted into fuel injector 10. Numerals in FIG. 5 that are consistent with the numerals in FIGS. 1,2,3 and 4 denote parts that are identical in both embodiments. This embodiment of the stator assembly 121 is distinguishable from the stator assembly 21 in FIG. 1 because the bottom surface 134 on the guide sleeve 131 is not planarly flush with the planar bottom surface 126 on the stator assembly 121. Therefore, the armature assembly 140 in this embodiment does not stop by contacting the bottom surface 134 on the guide sleeve 131 but rather, stops by contacting a bottom surface 183 on a spacer 180.

The guide piece 151 has a top impact surface 149. The top impact surface 149 of the guide piece 151 may be in contact with a spring 156 that biases the armature assembly 140 away from the stator assembly 121. The spring 156 is in contact with the guide piece 151 on one end of the spring 156 and in contact with a spacer 182 on the other end. The spacer 182 is in contact with another spacer 180 and their dimensions together with the dimensions of spacer 81 (not shown in FIG. 5, see FIG. 2) may be important in setting the initial and final air gaps, respectively, of the solenoid actuator assembly 120. More specifically, the length of the spacer 180 can be set to determine the final air gap. After grinding the armature assembly 140 and the stator assembly 121 to obtain a parallel orientation between the top surface 150 on the flux piece 145 and the bottom planar surface 126 on the stator assembly 121, the length of the spacer 180 is selected to set the desired final air gap 70. The final air gap 70 is the distance between the top surface 150 on the flux piece 145 and the planar bottom surface 126 on the stator assembly 121 when the bottom surface 183 of the spacer 180 comes into contact with the top impact surface on the guide piece 149. The spacer 182 is in contact with the spring 156 and it determines the preload on the spring 156. This preload should be determined such that when the solenoid actuator 120 is energized, the magnetic force biasing the armature towards spacer 180 is greater than the biasing force exerted by the spring 156 via the spacer 182. When the solenoid actuator 120 is de-energized, the spring 156 via the spacer 182 should have a biasing force great enough to move the armature assembly 140 away from the stator assembly 121 and come in contact with valve member 61.

Conventional wisdom in the art focuses on producing pieces with ever increasing tightened tolerances so that after attachment, the tolerance stack-ups would not amount to substantial variations. This disclosure resolves the problems faced by others in the art by allowing parts to be manufactured under less stringent tolerances, attaching the pieces together and then grinding the guide surfaces on the pieces in a single chucking to achieve a smaller final air gap. Referring now to FIGS. 1, 2, 3 and 4, one aspect of the disclosure teaches the step of grinding the inner diameter surface 32 on the guide sleeve 31 and the planar bottom surface 26 on the stator assembly 21 after assembling the guide sleeve 31 to the inner pole piece 24. These surfaces 32 and 26 can be ground in a single chucking allowing for greater precision in making the two surfaces 32 and 26 perpendicular relative to one another. In one embodiment, grinding the planar bottom surface 26 so that it is perpendicular to a longitudinal axis 35 of the guide bore 33 which is defined by the inner diameter surface 32 on the guide sleeve 31 may also produce a perpendicular orientation between the planar bottom surface 26 and the inner diameter surface 32. In an exemplary embodiment, the planar bottom surface 26 on the stator assembly 21 and a top surface 86 on the stator assembly 21 are ground simultaneously, in a single chucking, to ensure that both the surfaces 26 and 86 are parallel. The inner diameter surface 32 on the guide sleeve 31 can then be ground during the same chucking so that the inner diameter surface 32 is perpendicular to both the top and bottom planar surfaces 86 and 26 on the stator assembly 21. Various parts such as the stator assembly 21 and the valve assembly 60 including valve member 61 are stacked on top of each other within the fuel injector 10. Therefore, making the bottom and top surfaces of each assembly parallel to one another can reduce misalignments that may occur due to improper stacking. By having perpendicularity between the guide sleeve 31 and the bottom surface 26 on the stator assembly 21, an armature assembly 40 if made according to the correct specifications, may travel with much more accuracy within the guide sleeve 31 and consequently, improve parallelism between the top surface 50 on the flux piece 45 and the planar bottom surface 26 on the stator assembly 21. In addition, by grinding the surfaces 32 and 26 after attaching the guide sleeve 31 to the inner pole piece 24, less stringent tolerances will be required during the production of the respective parts, resulting in reduced production costs as well. One other aspect of the disclosure teaches grinding the stop surface 75 on the guide piece 43 after the flux piece 45 is attached to the guide piece 43. This produces an armature assembly 40 that compensates for the tolerance variations in the geometric dimensions of each individual piece while producing a much more accurate orientation between the guide piece 43 and the guide sleeve 31. The grinding step may be performed by grinding a stop surface 75 on the shoulder of the guide piece 43, such that the stop surface 75 is parallel to the flux piece 45 of the armature assembly 40 and is at a distance equivalent to the final air gap 70. Also, the grinding step can include grinding the guide surfaces 36 and 37 of the guide piece 43 and grinding the stop surface 75 on the guide piece 43 in a single chucking. This will allow a more improved orientation of the guide piece 43 into the guide bore 33 and also allow the guide piece 43 to have an orientation that is perpendicular to the flux piece 45, improving the parallelism between the flux piece 45 and the bottom planar surface 26.

In FIGS. 1, 2 and 3 the armature assembly 20 is shown in a first position. In the first position, the coil 29 is energized causing the solenoid actuator 20 to apply a pulling force on the armature assembly 40 bringing stop surface 75 of the armature assembly 40 in contact with the stop surface 77, which is part of the planar bottom surface 26 of the stator assembly 21. The armature assembly 40 may have a larger travel distance than the valve member 61 in order to be decoupled from the valve member 61. In this position, armature assembly 40 is out of contact with the valve member 61, resulting in a gap 71 between the armature assembly 40 and valve member 61. When the stop surface 75 on the guide piece 43 comes into contact with the stop surface 77 on the guide sleeve 31, there is a final air gap 70 between the planar bottom surface 26 and the top planar surface 50 on the flux piece 45. Furthermore, the first spring 56 remains in contact with the guide piece 43 and exerts a first preload bias force on the guide piece 43 in a direction away from stator assembly 21. The second spring 58 exerts a second preload bias on the valve member 61 forcing the valve member 61 to move from the lower valve seat 64 towards the upper valve seat 65 in a conventional manner.

In FIG. 5, the armature assembly 140 is shown in a position when the coil 29 is energized. The top surface 149 of the guide piece 151 is in contact with the bottom surface 183 of spacer 180. The spring 156 exerts a biasing force pushing the armature assembly 140 away from the stator assembly 121 but the magnetic force of the energized solenoid actuator 120 is greater than the biasing force of the first spring 156 and in the opposite direction as the biasing force of the spring 156. The flux piece 145 is not in contact with the planar bottom surface 126 on the stator assembly 121. When the guide piece 151 is in contact with the bottom surface 183 on spacer 80, the distance between the top surface 150 on the flux piece 145 and the planar bottom surface 126 on the stator assembly is the final air gap 70.

Referring back to FIGS. 1, 2 and 3, the armature assembly 40 moves toward a second position when the coil 29 is de-energized. The stop surface 75 on the guide piece 43 moves out of contact with the stop surface 77 on the guide sleeve 31. The guide piece 43, however, is in contact with valve member 61 and valve member 61 moves into contact with lower seat 64 under the action of first spring 56. Furthermore, the first spring 56 now has a greater pre-load than the pre-load of the second spring 58 so that valve member 61 will move to its lower seat when coil 29 is de-energized. The distance between the planar bottom surface 26 and the top planar surface 50 on the flux piece 45 along the longitudinal axis 35 of the guide bore 33 is equivalent to an initial air gap.

By decoupling the action of solenoid assembly 20 from valve member 61, slight misalignments between an axis of valve member 61 and guide axis 35 can be tolerated with altering performance. In addition, the speed of the valve member 61 moving between seats 64 and 65 are determined primarily by respective pre-loads on springs 56 and 58, which may be set precisely with respective spacers 80, 81 and 82. Seats 64 and 65 may be considered as first and second stops for valve member 61. The decoupled solenoid assembly 20 can now function with greater precision and may allow for a smaller initial and final air gap 69 and 70, respectively. Furthermore, by decoupling the armature assembly 40 and the valve member 61, the armature assembly 40 may function independently of the valve member 61 as long as the armature assembly 40 travels faster than the valve member 61. This also desensitizes the valve member 61 from any axial misalignments that may occur due to construction tolerance variances and any lateral shifting in the armature assembly 40 in order to improve parallelism between the armature assembly 40 and the stator assembly 21.

### INDUSTRIAL APPLICABILITY

The present disclosure finds potential application in any solenoid assembly in any machine. Although this particular embodiment of the disclosure is directed towards an electronically controlled valve assembly for use in a common rail fuel injector, the disclosure is not limited to fuel injectors and could find applicability in a much broader array of industries that use solenoid actuators. The present disclosure finds particular application to fuel injectors used in compression ignition engines. Other fuel injector applications include, but are not limited to, cam and/or hydraulically actuated fuel injectors. Electronically controlled valve assemblies may be used to control the flow of fluids and/or pressure through a fuel injector. In the present disclosure, the valve assembly performs repeated cycles of movement at an extremely high rate over many millions of cycles.

The solenoid actuator 20 has two states. An off or de-energized state, which corresponds to the second position of the armature assembly 40 and an on or energized state, which corresponds to the first position of the armature assembly 40. In the off state, the solenoid actuator 20 is switched off and no current is passing through the coil 29 of the solenoid actuator 20. As there is no current passing through the coil 29, there are no magnetic forces produced within the stator assembly 21. The first spring 56 exerts a force on the armature assembly 40 and the valve member 61 biasing them away from the stator assembly 21. The second spring 58 exerts an opposite force on the valve member 61 and the armature assembly 40 towards the stator assembly 21 but the force exerted by the second spring 58 is not great enough to overcome the force exerted by the first spring 56. Therefore, the net resulting force from the two springs 56 and 58 causes the valve member 61 to assume a second stop position in contact with the valve seat 64 that corresponds to either an open or a closed position, which in turn, controls the flow of fluid and/or pressure through the fuel injector 10 depending on the configuration of the valve assembly 60. The armature assembly 40 is positioned away from the planar bottom surface 26 and the distance from the planar surface 50 of the flux piece 45 to the planar bottom surface 26 of the stator assembly 21 along the longitudinal axis 35 of the guide bore 33 is the initial air gap.

As the solenoid actuator 20 is switched to its on state, the armature assembly 40 moves from its second position to its first position. Switching the solenoid actuator 20 on energizes the coil 29. The coil 29 produces a magnetic field around the stator assembly 21 and creates a magnetic force in the surrounding region. The force of the magnetic field is strong enough to pull the armature assembly 40 towards the stator assembly 21. This force is greater than the force of the spring 56 hence causing the armature assembly 40 to move towards the stator assembly 21. In addition, when the armature assembly 40 is pulled towards the stator assembly 21, the armature assembly 40 may be pulled faster than the valve member 61 is pushed upward by the second spring 58. This allows the armature assembly 40 to lose contact with the valve member 61. The valve member 61 moves from the second stop position to a first stop position that corresponds to either an open or a closed position which in turn controls the flow of fluid and/or pressure through the fuel injector 10 depending on the fluid configuration of the valve assembly 60. The guide piece 43 moves up the guide bore 33 of the stator assembly 21 maintaining a guide clearance with the guide sleeve 31. The guide piece 43 stops moving when the stop surface 75 on the guide piece 43 comes in contact with the stop surface 77 on the guide sleeve 31. A top surface 49 on the guide piece 43 remains in contact with the first spring 56. In another exemplary embodiment, the guide piece 151 can stop moving when the top impact surface 149 of the guide piece 151 comes into contact with a bottom impact surface 183 of spacer 180. In one embodiment, the distance between the planar bottom surface 26 of stator assembly 21 and the top surface 50 on the flux piece 45 is at its smallest distance, corresponding to the final air gap 70, and may be equal to the distance between the stop surface 75 on the guide piece 43 and the top surface 50 on the flux piece 45. When the armature assembly 40 is in the first position, the first spring 56 exerts a bias force on the guide piece 43. However, as long as the coil 29 is energized, the magnetic force is exerted on the armature assembly 40 and the armature assembly 40 remains in the first position. Depending on the fluid connections, fuel injection events may be initiated and ended by energizing and de-energizing solenoid actuator 20 in a known manner.

Finally, the solenoid actuator 20 is turned off again and the coil 29 is de-energized. The coil 29 no longer provides a magnetic force therefore allowing the net resulting force of the springs 56 and 58 to force the armature assembly 40 to move from the first position to the second position again. The first spring 56 exerts a force on the top surface 49 on the guide piece 43. The stop surface 75 on the guide piece 43 loses contact with the stop surface 77 on the guide sleeve 31, while the bottom impact surface 48 on the guide piece 43 comes back in contact with the valve member 61 pushing the valve member 61 back to its original position, and thereby allowing the valve member 61 to control the fluid flow and/or pressure through the fuel injector 10 again. The armature assembly 40 finally stops when it reaches the second position, wherein the distance between the flux piece 45 and the planar bottom surface 26 is equal to the initial air gap. In another embodiment, when the solenoid is de-energized, the guide piece 151 is forced away from the stator assembly 121 by the spring 156 making the top impact surface 149 of the guide piece 151 lose contact with the bottom impact surface 183 of the spacer 180.

The armature assembly 40 continues to move from the second position to the first position and back as long as the solenoid actuator 20 is turned on and turned off. This continuous process demonstrates why it may be important for the impact surfaces of the guide piece 43 to be made of a hard, impact resistant material. The repeated pounding of the bottom surface 48 and the stop surface 75 of the guide piece 43 with member 61 and the guide sleeve 31, respectively, cause wear and tear on the surfaces on the guide piece 43 possibly requiring the impact surfaces of guide piece 43 to be made of a material able to withstand these impacts over extended periods of use. It is known to those in the art that the flux piece 45 should be made of a soft material possessing superior magnetic properties in order to move between the first and second position with less force than might otherwise be needed. With the structure shown, the travel distance of valve member 61 will inherently be smaller than the travel distance of armature assembly 40.

This disclosure provides numerous ways to reduce the initial and final air gap of solenoid actuators and improve parallelism between the top surface 50 on the flux piece 45 and the bottom surface 26 on the stator assembly 21. Grinding the stop surface 75 on the guide piece 43, after attaching the flux piece 45 to the guide piece 43 to form the armature assembly 40, may permit smaller geometric variations than in the past. Grinding the surface 75 after the attaching step eliminates the need to develop parts with ever increasingly tightened geometric tolerances because the grinding step after attachment allows parts with larger geometric variations to be ground to the same predetermined dimensions. Furthermore, when the armature assembly 40 is ground (guide surfaces 36, 37 and stop surface 75) in a single chucking, the guide piece 43 and the flux piece 45 are oriented more accurately than if ground in more than a single chucking. This produces an improved, more geometrically aligned stop surface 75 on the guide piece 43 and better parallelism between the top surface 50 on the flux piece 45 and the planar bottom surface 26 of the stator assembly 21. Similar improvements can be achieved by grinding the inner surface 32 of the guide sleeve 31 and the planar bottom surface 26 of the stator assembly 21 as well. If the grinding is performed after attaching the guide sleeve 31 to the pole piece 24, less stringent tolerances may be needed to produce the stator assembly 21 with similar geometric details. Furthermore, grinding after attachment increases the perpendicularity between the guide sleeve 31 and the planar bottom surface 26 of the stator assembly 21, consequently improving parallelism between the top surface 50 of the flux piece 45 and the planar bottom surface 26 of the stator assembly 21.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A method of assembling a stator assembly of a solenoid actuator, wherein the stator assembly includes a pole piece and a guide sleeve, the method comprising the steps of:
attaching the guide sleeve into a pole bore defined in the pole piece;
forming a guide bore through the guide sleeve after the attaching step;
forming a planar bottom surface on the pole piece after the attaching step;
wherein the step of forming the guide bore through the guide sleeve and the step of forming the planar bottom surface on the pole piece includes a step of orienting one of an axis of the guide bore and the planar bottom surface on the pole piece perpendicular relative to the other of the axis of the guide bore and the planar bottom surface on the pole piece.

2. The method of assembling a stator assembly in claim 1 wherein the step of forming the guide bore through the guide sleeve includes a step of precision grinding the guide sleeve relative to the planar bottom surface on the pole piece.

3. The method of assembling a stator assembly in claim 2 wherein the step of forming the guide bore through the guide sleeve and the step of forming the planar bottom surface on the pole piece are performed in a single operation.

4. The method of assembling a stator assembly in claim 1 wherein the step of forming the planar bottom surface on the pole piece includes a step of forming a stop surface on the guide sleeve.

5. The method of assembling a stator assembly in claim 4 wherein, the step of forming the guide bore through the guide sleeve includes a step of precision grinding the guide sleeve relative to the planar bottom surface on the pole piece; and
the step of forming the guide bore through the guide sleeve and the step of forming the planar bottom surface on the pole piece and the step of forming the stop surface on the guide sleeve are performed in a single operation.

6. The method of assembling a stator assembly in claim 1 further including a step of receiving an armature in the guide bore of the guide sleeve wherein the attaching step includes a step of press fitting the guide sleeve into the pole bore.

7. The method of assembling a stator assembly in claim 6 wherein the step of forming the guide bore through the guide sleeve and the step of forming the guide bore through the guide sleeve and the step of forming the planar bottom surface on the pole piece are performed in a single operation.

8. The method of assembling a stator assembly in claim 1 further including a step of setting an air gap by selecting a spacer from one of a plurality of dimensionally different spacers.

9. The method of assembling a stator assembly in claim 1 further including a step of setting a preload with a spacer from one of a plurality of dimensionally different spacers.

10. A fuel injector assembly, comprising:
a solenoid actuator assembly including a stator assembly and an armature;
the stator assembly having a pole piece, a guide sleeve attached to the pole piece and a guide bore defined by an inner surface of the guide sleeve;
the guide bore having an axis and the pole piece having a planar bottom surface;
wherein one of the axis of the guide bore and the planar bottom surface on the pole piece is oriented perpendicular relative to the other of the axis of the guide bore and the planar bottom surface on the pole piece;
the armature having a guide piece and a flux piece, the armature being slidably movable between a first position where the armature is in contact with a stop surface and out of contact with a valve member, and a second position where the armature is out of contact with the stop surface and in contact with the valve member.

11. The fuel injector assembly of claim 10 wherein the guide piece is attached to the flux piece.

12. The fuel injection assembly of claim 11 wherein the guide piece is attached to the flux piece via welding.

13. The fuel injector assembly of claim 10 further including:
a first spring operatively positioned to bias the armature towards the valve member; and
a second spring operatively positioned to bias the valve member towards the armature.

14. The fuel injector assembly of claim 13 wherein energizing the stator assembly pulls the armature towards the first position against the bias of the first spring.

15. The fuel injector assembly of claim 13 wherein:
the first spring has a first preload;
the second spring has a second preload;
the first preload being greater than the second preload.

16. The fuel injection assembly of claim 15 wherein a spacer is located adjacent the first spring;
the armature being in contact with the spacer when the armature is in the first position.

17. The fuel injection assembly of claim 16 wherein the guide sleeve has a stop surface on a bottom surface of the guide sleeve;
the stop surface being in contact with the armature when the armature is in the first position.

18. The fuel injector assembly of claim 10 wherein:
the armature is guided via an interaction between the guide piece and the guide sleeve;
the armature has a first guide surface separated from a second guide surface by a reduced diameter surface; and
an air gap being defined by a distance between the flux piece and the planar bottom surface of the pole piece.

19. The fuel injector assembly of claim 10 wherein the stop surface is a bottom surface of the guide sleeve.

20. The fuel injector assembly of claim 10 wherein the stop surface is a spacer located adjacent a biasing spring.
